(19) United States
(12) Patent Application Publication
(10) Pub. No.: US 2003/0059364 A1
(43) Pub. Date: Mar. 27, 2003

(54) Method for poduction of nanostructures

(76) Inventor: Oleg Prilutskiy, Kibbutz Ruchama (IL)

Correspondence Address: Dekel Patent Ltd., Beit HaRof'im, Room 27, 18 Menuha VeNahala Street, Rehovot, IL

(21) Appl. No.: 09/957,247

(22) Filed: Sep. 21, 2001

(51) Int. Cl. D01F 9/12; C01B 31/02

(52) U.S. Cl. 423/447.3; 423/447.1; 423/445 R

(57) ABSTRACT

A method for production of nanostructures including gasifying a carbon-bearing material into a gas, thermal catalytic disproportionating the gas with a catalyst including a material including a Group VIII metal and with carbon monoxide so as to produce carbon including a nanostructure, the disproportionating also producing carbon dioxide as a byproduct, re-using the carbon dioxide to produce carbon monoxide, and introducing the carbon monoxide back into the thermal catalytic disproportionating.

### FIELD OF THE INVENTION

The present invention relates generally to nanotechnology and particularly to the production of nanostructures, such as differently shaped nanotubes, onions, endohedrons and fullerenes.

### BACKGROUND OF THE INVENTION

A variety of methods are known for the production of nanostructures. For example, intense heating of a graphite surface by an electric arc may be used to generate fullerenes, such as C₆₀ and C₇₀. Heating graphite, such as by an electric arc and/or a laser in a buffer gas environment, e.g., helium, under pressure, e.g., in a range of 50 to 100 or 500 torr, may be used to form carbon nanotubes. The carbon nanotubes may comprise nested concentric tubes of carbon where each tube is made up of curved graphite-like sheets of carbon. The tubes are hollow on the inside and the ends of the tube are usually sealed with fullerene-like caps. The same techniques may be used to generate giant fullerene-like carbon clusters as well. Irradiation with an electron beam may convert the tubes into concentric hollow spheres made of carbon. These carbon clusters are polygonal in shape and have onion-like structures, consisting of nested polygons of carbon layers.

Evaporated carbon fragments, produced as a result of the abovementioned high-temperature thermal graphite treatment, are generally condensed onto cooled walls of a vessel in which the process is conducted. The carbon black produced in this way is collected and subjected to extraction by dissolution (usually in non-polar solvents like benzene, toluene, etc.) and to further separation by methods of liquid chromatography.

However, carbon vaporization processes, while capable of making a wide variety of fullerenic structures, are very inefficient and not amenable to large-scale production. As an example, there may be a significant content of the ballast phase as opposed to the produced nanostructures. For example, the ballast phase may comprise 70-80% by mass of the produced carbon black material. There may also be a low content (in the range of a few percent) of nanotubes. Accordingly, there is generally an extremely high cost of the final product, thus preventing widespread use thereof.

Another method for producing nanotubes involves making single-wall carbon nanotubes by laser vaporizing a mixture of carbon and one or more Group VIII transition metals. Single-wall carbon nanotubes preferentially form in the vapor and the one or more Group VIII transition metals catalyze growth of the single-wall carbon nanotubes in a high temperature zone. However, this process is also inefficient and not amenable to large-scale production.

It is therefore desirable to develop a manufacturing process that is efficient and capable of processing large amounts of nanostructures.

### SUMMARY OF THE INVENTION

The present invention seeks to provide an improved manufacturing process that is efficient and capable of processing large amounts of nanostructures. Thermal catalytic decomposition or disproportionation of carbon-bearing gases and carbon monoxide in the presence of one or more transition metals of Group VIII (iron, cobalt, nickel, ruthenium or platinum, for example) and/or their compounds with other elements may be used to produce nanostructures. In one embodiment of the present invention, in contrast to the prior art, the process of carbon monoxide thermal catalytic disproportionation is carried out in a closed loop control circuit, wherein carbon dioxide, produced as a by-product of the catalytic disproportionation, is reacted with carbon (graphite, activated carbon, etc.) to produce carbon monoxide. The reaction may produce CO at a temperature exceeding 1000° C., for example. The closed loop control circuit significantly increases the production of the nanostructures and comprises an efficient mass-production process.

There is thus provided in accordance with a preferred embodiment of the present invention a method for production of nanostructures including gasifying a carbon-bearing material into a gas, thermal catalytic disproportionating the gas with a catalyst including a material including a Group VIII metal and with carbon monoxide so as to produce carbon including a nanostructure, the disproportionating also producing carbon dioxide as a byproduct, re-using the carbon dioxide to produce carbon monoxide, and introducing the carbon monoxide back into the thermal catalytic disproportionating.

In accordance with a preferred embodiment of the present invention, the method further includes extracting and separating the nanostructure from the carbon produced by the thermal catalytic disproportionating.

Further in accordance with a preferred embodiment of the present invention the gasifying includes oxidation of the carbon-bearing material at a temperature exceeding 1000° C.

Still further in accordance with a preferred embodiment of the present invention the thermal catalytic disproportionating is carried out at a temperature of about 400-700° C.

In accordance with a preferred embodiment of the present invention the thermal catalytic disproportionating includes disproportionating with a catalyst including at least one of a Group VIII metal, metal salt and metal hydroxide.

Further in accordance with a preferred embodiment of the present invention the thermal catalytic disproportionating is carried out in an inert gas medium.

Carbon nanostructures made with the methods of the present invention, may be used in a large variety of applications, such as but not limited to, electrical connectors in integrated circuits or semiconductor chips, antennas at optical frequencies, probes for scanning probe microscopy such as are used in scanning tunneling microscopes (STM) and atomic force microscopes (AFM), strengthening agents in composite materials, substitutes or additives for carbon black in tires for motor vehicles, and substitutes or additives for graphite fibers in applications such as airplane wings, golf club shafts and fishing rods, just to name a few.

### BRIEF DESCRIPTION OF THE DRAWINGS

The present invention will be understood and appreciated more fully from the following detailed description taken in conjunction with the appended drawings in which:

FIGS. 1 and 2 are simplified flow-chart and block-diagram illustrations, respectively, of a method for producing nanostructures, in accordance with a preferred embodiment of the present invention.

### DETAILED DESCRIPTION OF THE PRESENT INVENTION

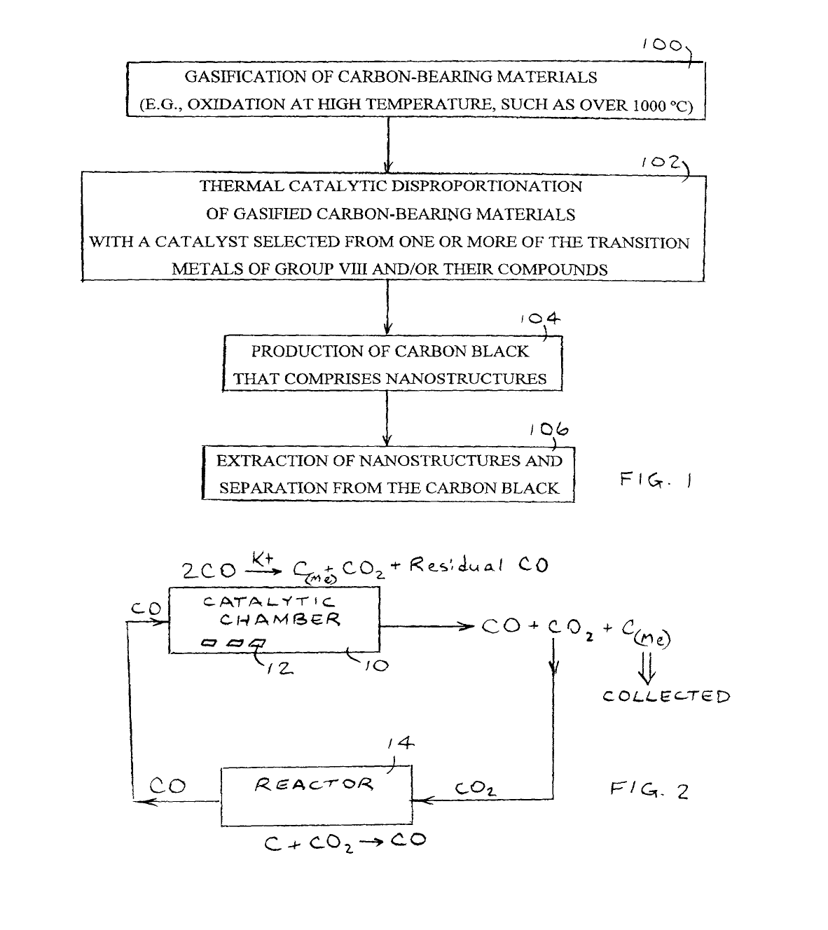

Reference is now made to FIGS. 1 and 2, which illustrate a method for producing nanostructures, such as but not limited to, nanotubes and fullerene-like structures, in accordance with a preferred embodiment of the present invention.

In one embodiment, carbon-bearing materials, such as but not limited to, graphite, undergo evaporation, also referred to as gasification (step 100 in FIG. 1). The graphite gasification may comprise oxidation of the carbon-bearing materials at a temperature, such as but not limited to, over 1000° C., for example. The gasified carbon-bearing materials may then undergo thermal catalytic disproportionation (step 102), which produces carbon black that comprises nanostructures (step 104). The thermal catalytic disproportionation of the gases may be carried out at a temperature, such as but not limited to, about 400-700° C., with a catalyst selected from one or more of the transition metals of Group VIII and/or their compounds with other elements. The Group VIII may comprise without limitation iron, cobalt, nickel, ruthenium or platinum, for example. The desired nanostructures may be extracted and separated from the carbon black (step 106), such as but not limited to, by means of dissolution (e.g., in non-polar solvents like benzene, toluene, etc.) and separation by liquid chromatography, for example.

In the oxidation of the carbon-bearing materials, carbon dioxide may be used as a carbon-bearing oxidant, wherein the product of oxidation is carbon monoxide. Accordingly, the thermal catalytic disproportionation of step 102 may comprise carbon monoxide disproportionation of Group VIII metals, metal salts or hydroxides (or other suitable compounds) that catalyze the production of nanostructures.

Referring to FIG. 2, carbon monoxide thermal catalytic disproportionation of the one or more Group VIII metals or compounds may be carried out in a catalytic chamber 10. The disproportionation may be carried out in the presence of an inert gas medium, such as but not limited to, helium. The catalyst may be coated onto one or more pads 12, such as but not limited to, pads formed as islands defined by particular target geometry and dimensions. The metal coating may be subjected to thermal oxidation in an oxygen-bearing gas medium, for example.

The chemical reaction of the carbon monoxide in the presence of the catalyst produces carbon (i.e., carbon black with the nanostructures) and carbon dioxide. The nanostructures may be extracted and separated from the carbon black as in step 106 in FIG. 1. In one embodiment of the present invention, the process of carbon monoxide thermal catalytic disproportionation is carried out in a closed loop control circuit, wherein carbon dioxide, produced by the catalytic disproportionation, is fed back to a reactor 14. The CO₂ reacts with carbon (such as but not limited to, graphite, activated carbon, and the like) in reactor 14 to produce carbon monoxide. The reaction may produce CO at a temperature exceeding 1000° C., for example.

The regenerated CO may then be fed back to catalytic chamber 10 for further thermal catalytic disproportionation, as described hereinabove, and the closed loop process starts over again.

It will be appreciated by person skilled in the art that the present invention is not limited by what has been particularly shown and described herein above. Rather the scope of the present invention is defined only by the claims that follow:

What is claimed is:

1. A method for production of nanostructures comprising:
gasifying a carbon-bearing material into a gas;
thermal catalytic disproportionating said gas with a catalyst comprising a material comprising a Group VIII metal and with carbon monoxide so as to produce carbon comprising a nanostructure, said disproportionating also producing carbon dioxide as a byproduct;
re-using said carbon dioxide to produce carbon monoxide; and
introducing said carbon monoxide back into said thermal catalytic disproportionating.

2. The method according to claim 1 and further comprising extracting and separating said nanostructure from said carbon produced by said thermal catalytic disproportionating.

3. The method according to claim 1 wherein said gasifying comprises oxidation of said carbon-bearing material at a temperature exceeding 1000° C.

4. The method according to claim 1 wherein said thermal catalytic disproportionating is carried out at a temperature of about 400-700° C.

5. The method according to claim 1 wherein said thermal catalytic disproportionating comprises disproportionating with a catalyst comprising at least one of a Group VIII metal, metal salt and metal hydroxide.

6. The method according to claim 1 wherein said thermal catalytic disproportionating is carried out in an inert gas medium.
